(19) United States
(12) Patent Application Publication
(10) Pub. No.: US 2007/0183412 A1
(43) Pub. Date: Aug. 9, 2007

(54) Facsimile servicing via peer-to-peer internet protocol telephony network

(75) Inventor: James D. Bennett, San Clemente, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/710,111

(22) Filed: Feb. 22, 2007

Related U.S. Application Data
(63) Continuation-in-part of application No. 11/348,962, filed on Feb. 7, 2006.
(63) Continuation-in-part of application No. 11/348,814, filed on Feb. 7, 2006.
(63) Continuation-in-part of application No. 11/348,743, filed on Feb. 7, 2006.
(63) Continuation-in-part of application No. 11/448,458, filed on Jun. 6, 2006.
(63) Continuation-in-part of application No. 11/641,196, filed on Dec. 18, 2006.

(51) Int. Cl. H04L 12/66

(52) U.S. Cl. 370/352

(57) ABSTRACT

Servicing an incoming Facsimile (FAX) communication includes receiving the incoming FAX communication by a source telephony bridging device via a source PSTN connection, the incoming FAX communication having an incoming FAX number associated therewith. Based upon the incoming FAX number, the source telephony bridging device determines a user ID in a peer-to-peer Voice over Internet Protocol (VOIP) network, determines an Internet Protocol (IP) address of a destination telephony bridging device based upon the user ID in the peer-to-peer VoIP network, and determines an outgoing FAX number based upon the user ID in the peer-to-peer VoIP network. The source telephony bridging device, an intermediate packet data network, and the destination telephony bridging device bridge the FAX communication from the source PSTN connection to a destination PSTN connection, the FAX communication directed to the outgoing FAX number.

### CROSS REFERENCES TO RELATED APPLICATIONS

This application is a continuation-in-part of the following co-pending applications:

1. Utility application Ser. No. 11/348,962, filed on Feb. 7, 2006, and entitled “TELEPHONE SUPPORTING BRIDGING BETWEEN A PACKET SWITCHED NETWORK AND THE PUBLIC SWITCHED TELEPHONE NETWORK” (BP5090);

2. Utility application Ser. No. 11/348,814, filed on Feb. 7, 2006, and entitled “COMPUTING DEVICE SUPPORTING BRIDGING BETWEEN A PACKET SWITCHED NETWORK AND THE PUBLIC SWITCHED TELEPHONE NETWORK” (BP5092);

3. Utility application Ser. No. 11/348,743, filed on Feb. 7, 2006, and entitled “SET TOP BOX SUPPORTING BRIDGING BETWEEN A PACKET SWITCHED NETWORK AND THE PUBLIC SWITCHED TELEPHONE NETWORK” (BP5091); and

4. Utility application Ser. No. 11/448,458, filed on Jun. 6, 2006, and entitled “TELEPHONY BRIDGING DEVICE SUPPORTING MULTIPLE PATHWAY TELEPHONY BRIDGING” (BP5272), and

5. Utility application Ser. No. 11/641,196, filed on Dec. 18, 2006, and entitled “FACSIMILE SERVICING VIA PEER-TO-PEER INTERNET PROTOCOL TELEPHONY NETWORK” (BP5809), all of which are incorporated by reference herein for all purposes.

### BACKGROUND OF THE INVENTION

1. Technical Field of the Invention

This invention relates generally to communication systems and more particularly to Voice over Internet Protocol (VOIP) telephony and to Public Switched Telephone Network (PSTN) telephony.

2. Description of Related Art

Voice telephony has been known for many years. Initially, voice telephony was supported by dedicated conductors between telephones. Then, voice telephony was enabled by operators manually switching connectors to create and tear down circuits between telephones. As technology advanced, mechanical components performed the switching operations to create and tear down circuits between telephones. With advancing technology, computers and semiconductor components replaced the mechanical components to perform circuit switching duties. Networks created using this circuit-switched technology are generally known as the Public Switched Telephone Network (PSTN). Generally, the PSTN provides a circuit-switched, time-divided connection between telephones.

Packet data communications, such as those supported by the Internet, differ from circuit-switched communications. With packet data communications, a source device forms a data packet, transmits the data packet to a packet data network, and based upon a destination address, e.g., Internet Protocol (IP) address of the data packet, the packet data network passes the data packet to a destination device. As the Internet and other packet data networks grew in popularity, packet switched voice telephony was developed. One common type of packet switched voice telephony is Voice over Internet Protocol (VOIP) telephony. When VoIP telephony was first introduced, the data packet transmission latency of the Internet and of other servicing networks caused the quality of VoIP telephony to be significantly worse than that of PSTN telephony. Over time, packet data transmission latency of the Internet and of other servicing packet data networks has decreased. Now, VoIP telephony provides service quality equal to or better than VoIP telephony in many cases.

Recently developed VoIP telephony applications enable computer users to establish non-toll VoIP telephone calls across the Internet. Compared to PSTN telephony VoIP telephony of this type is significantly less expensive, particularly for overseas calls. However, only a limited number of people have a computer upon which this VoIP telephony application may be loaded and have Internet access of a quality that will support the VoIP telephony application.

In order to gain some advantages of VoIP telephony but still service consumers having PSTN telephones, VoIP telephony service providers typically deploy VoIP gateways. The VoIP gateways bridge communications between the PSTN (PSTN telephony call) and the Internet (VoIP telephony call). VoIP telephony service providers typically extract a toll for servicing a call via the VoIP gateway bridge, thus destroying in part the low cost attractiveness of VoIP telephony. Thus, a need exists for systems and methods of operations that overcome the shortcomings of these prior telephony systems.

Facsimile (FAX) broadcast service providers often send large numbers of FAXes to differing end point devices, e.g., FAX machines. The broadcast of FAX transmissions can be complex and costly. Broadcast FAX systems typically complete a single transaction for each end point device. Each of these facsimile transmissions consumes resources of the PSTN and is billed by the PSTN service provider. While broadcast FAX service providers may obtain block rates for PSTN usage, because the destination FAX machines (end point devices) often are distributed across vast geographic areas, the toll charges for PSTN usage is often times still substantial. Thus, limitations exist in broadcast FAX communication systems.

Businesses often receive FAX transmissions from source devices (FAX machines) that are distributed across vast geographic areas, resulting in PSTN toll charges for the incoming FAXes. One solution to paying for the PSTN toll charges is to setup a toll free number for the receipt of the FAX communications. However, this toll free number can be expensive to setup and operate. Another option is to require that the senders of the FAX communications pay for PSTN toll charges. Requiring a sender of the FAX to pay for the PSTN costs is an impediment to receiving FAX communications. This problem is especially pronounced when the recipient of the FAXes has great interest in receiving the FAXes but the sender has little or no interest in transmitting the FAXes.

### BRIEF SUMMARY OF THE INVENTION

The present invention is directed to apparatus and methods of operation that are further described in the following Brief Description of the Drawings, the Detailed Description of the Drawings, and the Claims. Other features and advantages of the present invention will become apparent from the following detailed description of the invention made with reference to the accompanying drawings.

### BRIEF DESCRIPTION OF THE SEVERAL VIEWS OF THE DRAWINGS

FIG. 1 is a system diagram illustrating a facsimile (FAX) communication system constructed according to one or more embodiments of the present invention;

FIG. 2 is a system diagram illustrating an alternate construction of the system of FIG. 1, particularly relating to the receipt of FAX communications according to embodiments of the present invention;

FIG. 3 is a flow chart illustrating a method for receiving FAX communications according to a first embodiment of the present invention;

FIGS. 4A and 4B are flow charts illustrating methods for receiving FAX communications according to a second embodiment of the present invention;

FIG. 5 is a block diagram illustrating a telephony bridging device constructed according to one or more embodiments of the present invention;

FIG. 6 is a system diagram illustrating an alternate embodiment of the system of FIG. 1 used to service the broadcast FAX transmissions according to at least one embodiment of the present invention;

FIG. 7 is a flow chart illustrating a method for servicing broadcast FAX communications according to one or more embodiments of the present invention;

FIG. 8 is a flow chart illustrating another embodiment for the broadcast of FAX communications according to embodiments of the present invention; and

FIG. 9 is a system diagram illustrating the construction and operation of a plurality of telephony bridging devices according to embodiments of the present invention.

### DETAILED DESCRIPTION OF THE INVENTION

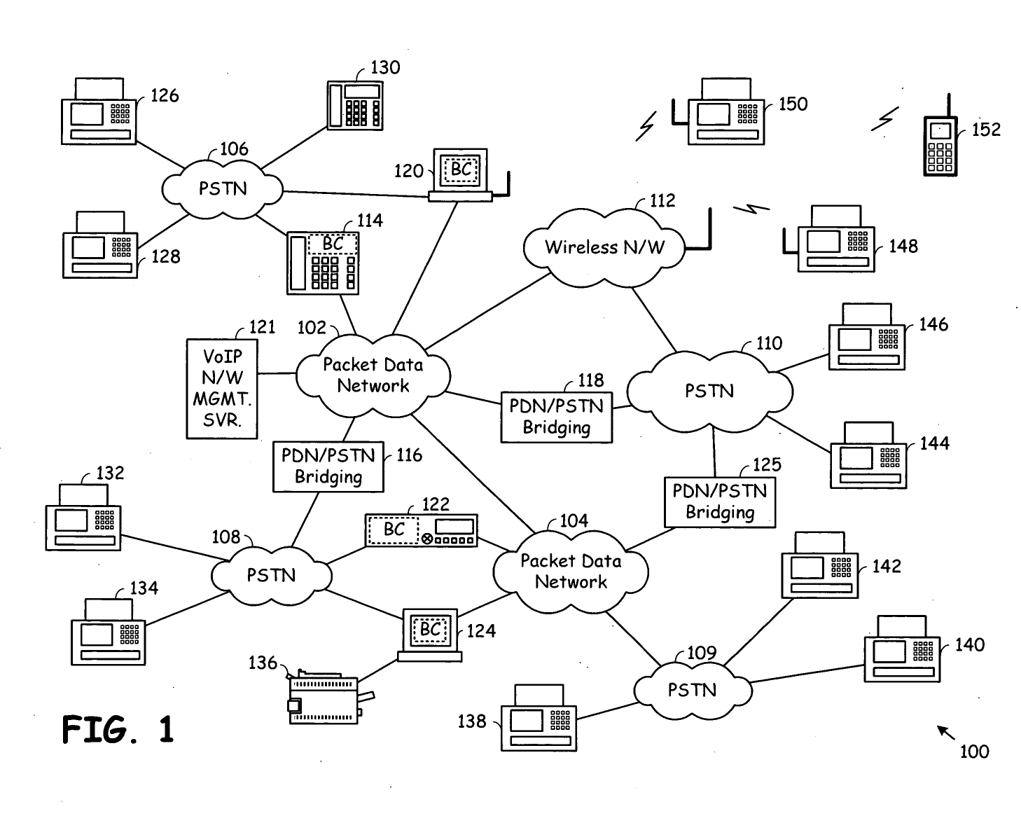

FIG. 1 is a system diagram illustrating a facsimile (FAX) communication system constructed according to one or more embodiments of the present invention. The FAX communication system 100 of FIG. 1 is constructed according to various aspects of the present invention and is operable to service FAX communications according to the present invention. Servicing FAX communications according to the present invention include methodologies for receiving FAX communications, methodologies for transmitting FAX communications, and methodologies for passing FAX communications through the infrastructure of the FAX communication system 100 of FIG. 1, many of which bridge the FAX communications between differing network types.

The system 100 of FIG. 1 includes packet data networks 102 and 104. These packet data networks 102 and 104 include one or more types of packet data networks including the Internet, the World Wide Web, one or more Wide Area Networks (WANs), one or more Local Area Networks (LANs), and/or one or more other types of packet data networks. Also shown in the system 100 of FIG. 1 are a plurality of Public Switched Telephone Network (PSTN) segments 106, 108, 109, and 110. These PSTN segments 106, 108, 109, and 110 are circuit switched networks in one embodiment. In another embodiment, the PSTN segments 106, 108, 109, and 110 are a combination of circuit switched and packet switched networks. Typically, the PSTN segments 106, 108, 109, and 110 are operated by PSTN service providers, which charge for usage of the PSTN segments. Thus, access of PSTN segments 106, 108, 109, and 110 is had based upon a usage basis or a flat-rate basis. PSTN segment 106 supports FAX machines 126, 128 and supports telephone 130. PSTN segment 108 supports FAX machines 132 and 134. PSTN segment 109 supports FAX machines 138, 140, and 142. PSTN segment 110 supports FAX machines 144 and 146. Wireless network 112 supports FAX machines 148 and 150 and wireless handset 152.

Wireless network 112 may be one or more of a cellular network, a Wireless Wide Area Network (WWAN), a Wireless Local Area network (WLAN), a Wireless Personal Area Network (WPAN) such as a Bluetooth network, and/or a combination of one or more of these types of networks. When the wireless network 112 comprises a cellular network, for example, the wireless network 112 supports one or more of a GSM communication protocol, a CDMA communication protocol, a WCDMA communication protocol, a TDMA communication protocol, or another type of cellular network communication protocol to support communications with cellular enabled devices. When the wireless network 112 includes WLAN support, the wireless network 112 supports one or more versions of IEEE 802.11. Further, when the wireless network 112 includes a WWAN, the wireless network 112 may support the WiMAX operating standard. Further, when the wireless network 112 includes a WPAN network, it may support the Bluetooth operating standard.

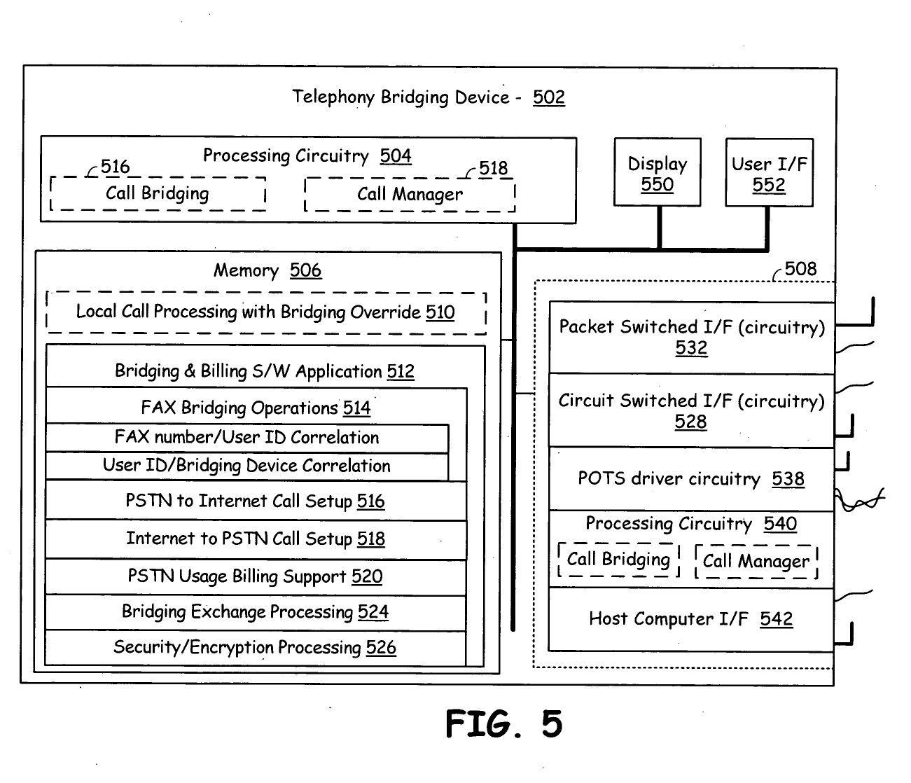

According to the present invention, the system 100 includes a plurality of telephony bridging devices that are operable to bridge communications between a PSTN connection and a packet data network connection, i.e., between a coupled PSTN segment and a coupled packet data network. For example, telephony bridging device 114 includes bridging circuitry (BC) and interfaces to both PSTN segment 106 and packet data network 102. Telephony bridging device 114 is operable to communicate with PSTN segment 106 via a respective PSTN connection and with packet data network 102 via a respective packet data network connection. In some operations, telephony bridging device 114 accesses the PSTN segment 106 directly and in other operations it accesses packet data network 102 directly, without bridging communications there between. In still other operations, the telephony bridging device 114 bridges communications between the PSTN segment 106 and the packet data network 102. An example of a structure of telephony bridging device 114 is shown and described further herein with reference to FIG. 5.

Telephony bridging devices may take the form of telephones, computers, set-top boxes, and other types of particular structures. For example, telephony bridging device 116 takes a generic format and bridges communications between PSTN segment 108 and packet data network 102. Telephony bridging device 118, also taking a generic format, is operable to bridge communications between packet data network 102 and PSTN segment 110. Telephony bridging device 125 takes a generic format and bridges communications between PSTN segment 110 and packet data network 104. Set-top box 122, which includes bridging circuitry, is operable to bridge communications between PSTN segment 108 and packet data network 104. The set-top box 122 provides additional functions as well such as traditional set-top box operations for a serviced monitor and entertainment system. Telephony bridging device 124 takes the form of a personal computer and is operable to bridge communications between PSTN segment 108 and packet data network 104. Telephony bridging device 124 is further operable to service printer 136. Finally, telephony bridging device 120 takes the form of a personal computer and is operable to bridge communications between PSTN segment 106 and packet data network 102. Further, the telephony bridging device 120 is also operable to bridge communications between wireless devices such as FAX machine 150 and PSTN segment 106 and/or packet data network 102. The VoIP Network Management Server 121 is operable to assist the bridging operations of the telephony bridging devices 114, 116, 118, 120, 122, 124, and 125 according to the present invention.

The structure and operations of telephony bridging devices are described further in co-pending applications:

1. Utility application Ser. No. 11/348,962, filed on Feb. 7, 2006, and entitled “TELEPHONE SUPPORTING BRIDGING BETWEEN A PACKET SWITCHED NETWORK AND THE PUBLIC SWITCHED TELEPHONE NETWORK” (BP5090);

2. Utility application Ser. No. 11/348,814, filed on Feb. 7, 2006, and entitled “COMPUTING DEVICE SUPPORTING BRIDGING BETWEEN A PACKET SWITCHED NETWORK AND THE PUBLIC SWITCHED TELEPHONE NETWORK” (BP5092);

3. Utility application Ser. No. 11/348,743, filed on Feb. 7, 2006, and entitled “SET TOP BOX SUPPORTING BRIDGING BETWEEN A PACKET SWITCHED NETWORK AND THE PUBLIC SWITCHED TELEPHONE NETWORK” (BP5091); and

4. Utility application Ser. No. 11/448,458, filed on Jun. 6, 2006, and entitled “TELEPHONY BRIDGING DEVICE SUPPORTING MULTIPLE PATHWAY TELEPHONY BRIDGING” (BP5272), and

5. Utility application Ser. No. 11/641,196, filed on Dec. 18, 2006, and entitled “FACSIMILE SERVICING VIA PEER-TO-PEER INTERNET PROTOCOL TELEPHONY NETWORK” (BP5809), which are incorporated herein by reference for all purposes, and will be described further herein only as they relate to aspects of the present invention.

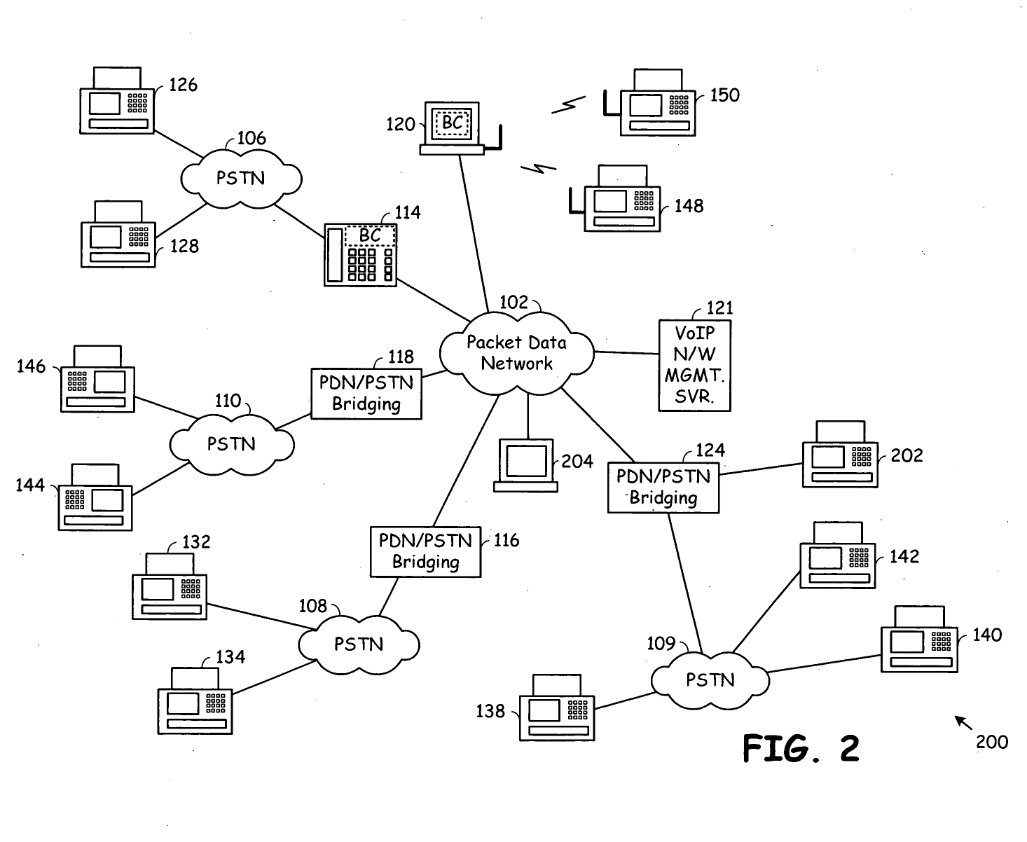

FIG. 2 is a system diagram illustrating an alternate construction of the system of FIG. 1, particularly relating to the receipt of the FAX communications according to embodiments of the present invention. As contrasted to the system 100 of FIG. 1, the system 200 of FIG. 2 further includes FAX machine 202 and computer 204 which were not previously illustrated in FIG. 1. Components common to FIG. 1 retain common numbering with the system 200 of FIG. 2. Some components of FIG. 1 are not reproduced in FIG. 2. The system 200 of FIG. 2, among other operations, services incoming FAX communications. With a first example of these operations, incoming FAX communications are intended for FAX machine 146 that couples to PSTN segment 110. According to the present invention, one or more of FAX machines 126, 128, 132, 134, 138, 140, 142, 144, 148, 150, and 202 transmit FAX communications intended for FAX machine 146. Each FAX machine that is not coupled to PSTN segment 110 that is transmitting a FAX communication intended for FAX machine 146 is serviced by a source telephony bridging device that convert the FAX communication to a packet data format and transmit the FAX communication via a packet data network.

For example, FAX machines 138, 140, and 142 couple to PSTN segment 109 and are serviced by source telephony bridging device 124. FAX communications sent from FAX machines 138, 142, and 140 are intercepted by source telephony bridging device 124 via a source PSTN connection. The source telephony bridging device 124, based upon the incoming FAX number, determines a user ID in a peer-to-peer voice over Internet protocol (VOIP) network. Determination of the user ID is made typically via interaction with VoIP network management server 120. However, in another operation, the user ID is determined locally by the source telephony bridging device 124 based upon information stored therein (and the destination PSTN number of the FAXes, for example). Then, the source telephony bridging device 124 determines an Internet protocol (IP) address of a destination telephony bridging device 118 based upon the user ID in the peer-to-peer VoIP network. Determination of the destination telephony bridging device 118 may also be determined based upon the destination PSTN telephone number of the FAX communication, the user ID, or using another technique.

Further, operation according to the present invention as performed by the system 200 of FIG. 2 determines an outgoing PSTN FAX number based upon the user ID in the peer-to-peer VoIP network. This outgoing PSTN FAX number corresponds to FAX machine 146. Then, the source telephony bridging device 124, intermediate packet data network 102, and destination telephony bridging device 118 bridge the FAX communications from the source PSTN connection of the source telephony bridging device 124 to a destination PSTN connection of destination telephony bridging device 118. The FAX communication is then directed via the PSTN segment 110 to an outgoing FAX number corresponding to FAX machine 146.

Thus, according to the present invention, FAX communications transmitted by FAX machines 138, 140, and 142 are not sent directly via the PSTN to FAX machine 146. Instead, these FAX communications are bridged by source telephony bridging device 124, the packet data network 102, and destination telephony bridging device 118 and PSTN segment 110 to destination FAX machine 146. By bridging these incoming FAX communications across the packet data network 102, PSTN toll charges are minimized or eliminated, particularly when the PSTN calls serviced by PSTN segment 109 and 110 are local calls.

Likewise, the FAX communications transmitted by FAX machines 132 and 134 are transmitted across PSTN segment 108 to source telephony bridging device 116. The source telephony bridging device 116 bridges the FAX communications received from FAX machines 132 and 134 via the packet data network 102 and destination telephony bridging device 118 to PSTN segment 110, which forwards the FAX communication to FAX machine 146. Moreover, FAX communications transmitted from FAX machines 148 and 150 are bridged by source telephony bridging device 120 and destination telephony bridging device 118 via packet data network 102 to PSTN segment 110, which delivers the FAX communications to FAX machine 146. Further, FAX communications transmitted by FAX machines 126 and 128 are conveyed by PSTN segment 106 to source telephony bridging device 114. Source telephony bridging device 114 bridges the FAX communications received from FAX machines 126 and 128 via packet data network 102 and destination telephony bridging device 118 to PSTN segment 110, which delivers the FAX communications to FAX machine 146.

Some incoming FAX communications may be transmitted directly via PSTN segment 110 to FAX machine 146. For example, a FAX communication incoming from FAX machine 144 may be delivered directly to FAX machine 146 via PSTN connection 110.

In another example of an operation of the system 200 of FIG. 2, FAX machine 202 is the destination FAX machine for FAX communications transmitted by other of the FAX machines illustrated. In such case, FAX communications sent by FAX machine 134, for example, are received by source telephony bridging device 116 via PSTN segment 108. Based upon the incoming FAX number associated with the FAX communication, the source telephony bridging device 116 determines a user ID in the peer-to-peer VoIP network. Then, based upon this user ID, the source telephony bridging device 116 determines an IP address of destination telephony bridging device 124. The source telephony bridging device 116 then delivers the FAX communication via the packet data network 102 to the destination telephony bridging device 124. However, instead of delivering the FAX communication to PSTN segment 109, the destination telephony bridging device 124 delivers the FAX communication to FAX machine 202 instead.

In yet another example of operation according to the present invention, a FAX communication transmitted from FAX machine 128 and intended for computer 204 is sent via PSTN segment 106 and received by source telephony bridging device 114, which bridges the FAX communication to computer 204 via packet data network 102. Thus, in such case, a destination telephony bridging device is not required. In the case of this example of operation, the source telephony bridging device 114 may convert the FAX communication from a PSTN format to an image data format. Then, the FAX communication is delivered to computer 204 in the image data format.

In various operations according to present invention, the PSTN segments 106, 108, 109, and 110 are geographically remote from one and other. Thus, by bridging the FAX communications across the packet data network 102, significant PSTN toll charges are minimized or eliminated. Further, in transmitting the FAX communications across the packet data network 102, a source telephony bridging device such as telephony bridging device 118 may convert the FAX communication from a PSTN format to a packetized audio format. Then, a destination telephony bridging device, for example, destination telephony bridging device 116, may convert the FAX communication from the packetized audio format to the PSTN format. In such case, the audio information representing the FAX communication would retain its audio format but, be converted from a circuit switched to a packet switched format. In another operation according to the present invention, the source telephony bridging device, e.g., source telephony bridging device 118 converts the FAX machine from the PSTN format (audio format) to an image data format such as a TIF format or a PDF format. Then, destination telephony bridging device 116 converts the FAX communication from the image data format to the PSTN format for transfer to PSTN segment 108 to a destination FAX machine 134, for example.

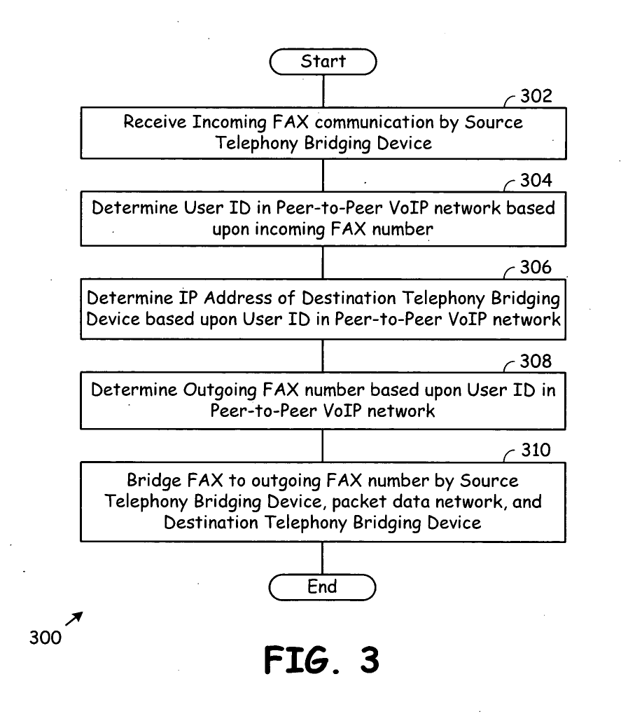

FIG. 3 is a flow chart illustrating a method for receiving FAX communications according to a first embodiment of the present invention. Operation 300 commences with a source telephony bridging device receiving an incoming FAX communication via a source PSTN connection (Step 302). The incoming FAX communication has associated therewith an incoming FAX number. Then, based upon the incoming FAX number, a user ID and a peer-to-peer VoIP network is determined (Step 304). The source telephony bridging device may determine this user ID in the peer-to-peer VoIP network based upon access of a VoIP network management server 120, based upon access of local information, or a combination of these two operations.

Then, the source telephony bridging device determines an IP address of a destination telephony bridging device based upon the user ID in the peer-to-peer VoIP network (Step 306). The source telephony bridging device or the destination telephony bridging device may then determine an outgoing FAX number based upon the user ID and the peer-to-peer VoIP network (Step 308). Alternately, the VoIP network management server 120 determines the outgoing FAX number based upon the user ID in the peer-to-peer VoIP network and returns this information along with the IP address of the destination telephony bridging device. The source telephony bridging device, an intermediate packet data network, and the destination telephony bridging device then bridge the FAX communication from the source PSTN connection of the source telephony bridging device to a destination PSTN connection of a destination telephony bridging device. The FAX communication is then directed towards the outgoing FAX number (Step 310). As was previously described with reference to FIG. 2, the operations of FIG. 3 may be performed for a plurality of FAX communications that are incoming from a plurality of differing FAX machines.

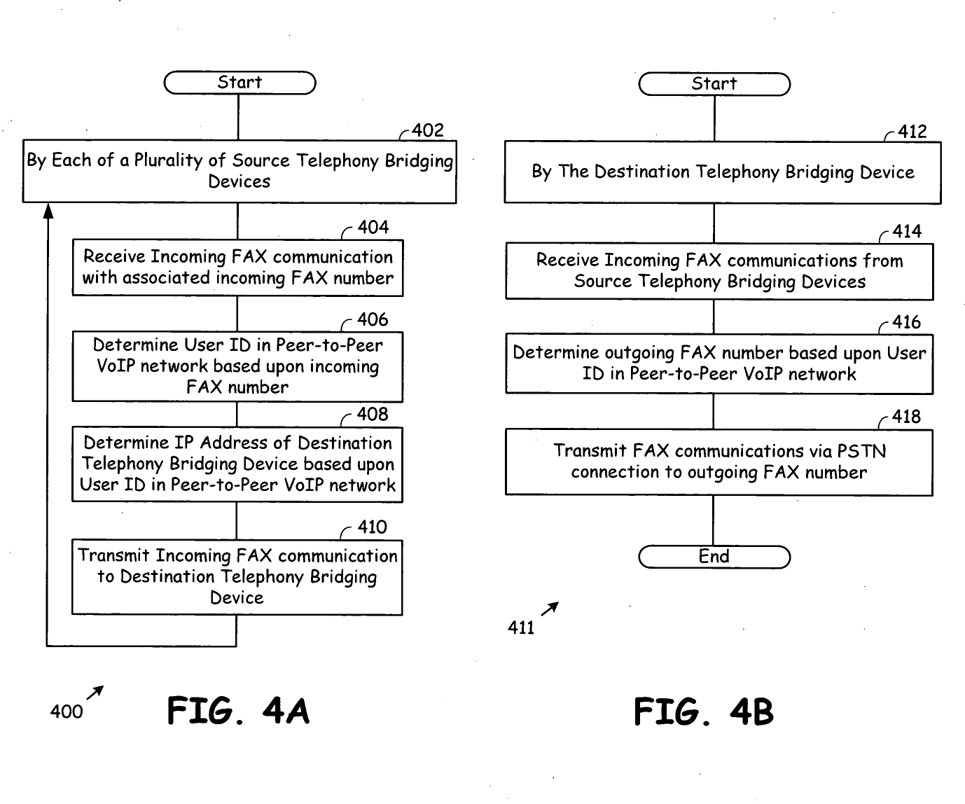

FIGS. 4A and 4B are flow charts illustrating methods for receiving FAX communications according to a second embodiment of the present invention. Referring to FIG. 4A, for each of a plurality of telephony bridging devices (Step 402), the source telephony bridging device receives an incoming FAX communication with an associated incoming FAX number (Step 404). The source telephony bridging device then determines a user ID in a servicing peer-to-peer VoIP network based upon the incoming FAX number (Step 406). Then, the source telephony bridging device and/or a management server of the VoIP network determines an IP address of a destination telephony bridging device based upon the user ID in the peer-to-peer VoIP network (Step 408). Then, the source telephony bridging device transmits the incoming FAX communication to the destination telephony bridging device (Step 410). Operations 404-410 are repeated for each of the plurality of source telephony bridging devices.

With reference to FIG. 4B, operation commences by operation of a destination telephony bridging device (Step 412). The destination telephony bridging device receives incoming FAX communications from one or more source telephony bridging devices (Step 414). Based upon the user ID, the destination telephony bridging device may determine an outgoing FAX number for forwarding the FAX communication (Step 416). In an alternate embodiment, the destination telephony bridging device receives the outgoing FAX number along with the FAX communication. The destination telephony bridging device then transmits the FAX communication via its PSTN connection to the outgoing FAX number (Step 418).

FIG. 5 is a block diagram illustrating a telephony bridging device constructed according to one or more embodiments of the present invention. The telephony bridging device 502 includes processing circuitry 504, memory 506, interface circuitry 508, a display 550, and a user interface 552. The processing circuitry 504 may be a single processing device or a plurality of processing devices. The processing circuitry 504 may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The memory 506 may be a single memory device, a plurality of memory devices, and/or embedded circuitry of the processing circuitry 504. The memory 506 may be a read-only memory, random access memory, volatile memory, non-volatile memory, static memory, dynamic memory, flash memory, cache memory, and/or any device that stores digital information. Note that when the processing circuitry 504 implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Further note that, the memory 506, and the processing circuitry 506 executes, hard coded and/or operational instructions corresponding to at least some of the steps and/or functions illustrated in FIGS. 1-4 and 6-9. The display 550 and user interface 552 support local interaction with the telephony bridging device 502 by a user. The display 550 may be employed to display current bridging activity of the telephony bridging device 502.

The interface circuitry 508 includes circuit switched interface circuitry 528, packet switched interface circuitry 532, POTS driver circuitry 538, and may include processing circuitry 540 and/or a host computer interface 542. The circuit switched interface circuitry 528 interfaces the telephony bridging device 502 to the PSTN via one or more wired and/or wireless links. The circuit switched interface circuitry 528 may include a wired link to the PSTN, a wireless link to the PSTN, a wireless link to a cellular network, a fiber optic link to the PSTN, or another circuit switched link. The packet switched interface circuitry 532 interfaces the telephony bridging device 502 to one or more packet switched networks, e.g., the Internet, one or more WANs, one or more LANs, etc., via one or more wired and/or wireless links. The packet switched interface circuitry 532 supports one or more wired packet switched interface standards including Ethernet, for example, and/or other one or more wireless interface standards including any of the IEEE 802.11x interface standards, the WiMAX operating standard, a Digital cable operating standards such as DOCSIS, a satellite communication operating standard, or other wireless interface standards.

The POTS driver circuitry 538 interfaces the telephony bridging device 502 to a POTS telephony device via either a wired or a wireless interface. The POTS driver circuitry 538 generates and delivers POTS signaling to the POTS telephony device. This POTS signaling is equivalent to POTS signaling provided by a Central Office of a PSTN telephone company over twisted pair wiring to a POTS telephone. Such POTS signaling may be provided over a twisted pair of copper conductors or via a wireless connection. In either case, the POTS driver circuitry 538 appears to the POTS telephony device that it is connected directly to a central office of the PSTN. The processing circuitry 504 and/or the processing circuitry 540 of the communication interface 508 is capable of bridging calls between every two of the POTS driver circuitry 538, the circuit switched interface circuitry 528, and the packet switched interface circuitry 532. The host computer interface 542, when present, interfaces the telephony bridging device 502 to a host computer via an expansion card interface, a serial interface, a parallel interface, a wireless interface, or another interface that supports communications between the telephony bridging device 502 and a host computer.

The memory 506 stores software instructions that, when executed by processing circuitry 504 and/or 542, cause the telephony bridging device 502 to operate according to the present invention. Generally, these software instructions include local call processing with bridging override operation instructions 510 and bridging and billing software application operation instructions 512. The bridging and billing software application operation instructions 512 include FAX bridging operation instructions 514, which include FAX number/User ID correlation operation instructions and User ID/Bridging device correlation operation instructions. The bridging and billing software application operation instructions 512 further include PSTN to Internet call setup operation instructions 516, Internet to PSTN call setup operation instructions 518, PSTN usage billing support operation instructions 520, bridging exchange processing operation instructions 524, and security/encryption processing operation instructions 526.

Referring particularly to the local call processing with bridging override instructions 510, upon execution, the processing circuitry 506 and/or 542 enables the telephony bridging device 502 to locally process calls to override bridging operations of the telephony bridging device 502. In its normal operations, the telephony bridging device 502 is available to bridge calls between its packet switched interface circuitry 532 and its circuitry switched interface circuitry 528. However, during such bridging operations, a local subscriber may desire to access the PSTN or the Internet via the POTS driver circuitry 538 and a coupled POTS telephony device that would interrupt or compromise the currently bridged call. The local call processing with bridging override functionality 510 establishes rules that allow the user to access and disrupt a currently bridged call or not depending upon the particular rules established. With the particular operation, a local subscriber (user of POTS telephony device) may always interrupt a currently bridged call, sometimes interrupt a currently bridged call, or never interrupt a currently bridged call. The ability of a local subscriber/user to interrupt a locally bridged call may be based upon access rules that are obtained from a remote location or locally stored.

The PSTN to Internet call setup operation instructions 516 support another PSTN device coupled to the telephony bridging device 502 to setup an Internet call from a calling PSTN terminal. In such case, the PSTN to Internet call setup functions 516 provide audio caller ID functions, touch tone voice mail vectoring operations, or other interface operations that allow a user of a remote PSTN telephone to interact with the telephony bridging device 502. Based upon the communications supported by the PSTN to Internet call setup operation instructions 516, the remote PSTN user may setup the telephony bridging device 502 for call bridging operations. The Internet to PSTN call setup operation instructions 518 allow a remote VoIP terminal itself to setup call bridging by the telephony bridging device 502. This functionality may be via a web page interface, a simpler data communication interface that causes exchanges sufficient information to enable the Internet to PSTN call setup to occur, or via another interface.

The PSTN usage and billing support operation instructions 520 allow the telephony bridging device 502 to determine PSTN usage by a non-local subscriber for future billing operations. The PSTN usage billing support instructions 520 may interface the telephony bridging device 502 with the billing management software of a service provider server 320. For example, if the telephony bridging device 502 performs call bridging for a remote VoIP or PSTN terminal, the call may be bridged not only to a local PSTN telephone but also to a non-local PSTN telephone wherein additional PSTN tolls are incurred. Any usage of the PSTN while servicing a bridged telephone call may result in PSTN billing to the telephony bridging device 502. The PSTN usage billing support functionality 520 supports capturing of such PSTN usage by the telephony bridging device 502 and subsequent interaction with a server or with another device to cause PSTN usage billing to the appropriate remote subscriber or terminal.

The bridging exchange processing operation instructions 524 causes the telephony bridging device 502 to track usage of remote subscribers for call bridging operations and to track usage of a local subscriber of remote telephony bridging devices. This functionality may operation in conjunction with a bartering system that tracks usage of various subscribers to the bartering system. In such case, these operations may ensure that usage of telephony bridging devices by differing subscribers is equitable. If the operations are not equitable, the bridging exchange processing operations may cause notification or bills to be sent to a subscriber that uses more than an equitable amount or number of call bridging operations.

The security/encryption processing operation instructions 526 of the telephony bridging device 502 are enacted to: (1) preclude a local user from listening in on bridged calls, and (2) to preclude remote users from listening on communications of a local user of the telephony bridging device 502. Security/encryption processing operations 526 may actually mask or encrypt data communications to preclude the coupled POTS telephony device from eavesdropping on communications that are bridged.

According to its operations as a source telephony bridging device 502 as enabled by the FAX bridging operation instructions 514, the telephony bridging device 502 receives a FAX communication via its circuit switched interface circuitry 528. Processing circuitry 504 or 540 based upon directives made by execution and instructions from memory performs all bridging and call manager operations to bridge the FAX communication. Such bridging may include bridging the FAX communication between the packet switched interface 532 and the circuits, which interface 528. In another operation, the FAX communication is not bridged but stored in memory 506 with the telephony bridging device 502 being the destination for the FAX communication.

In another embodiment, or another operation, the telephony bridging device 502 receives the FAX communication via a packet switched interface circuitry 532 and bridges the FAX communication out its circuit switched interface 528. As referred to herein, the circuit switched interface circuitry 528 has associated therewith a PSTN connection. Further, the packet switched interface circuitry 532 has associated therewith a packet data network connection.

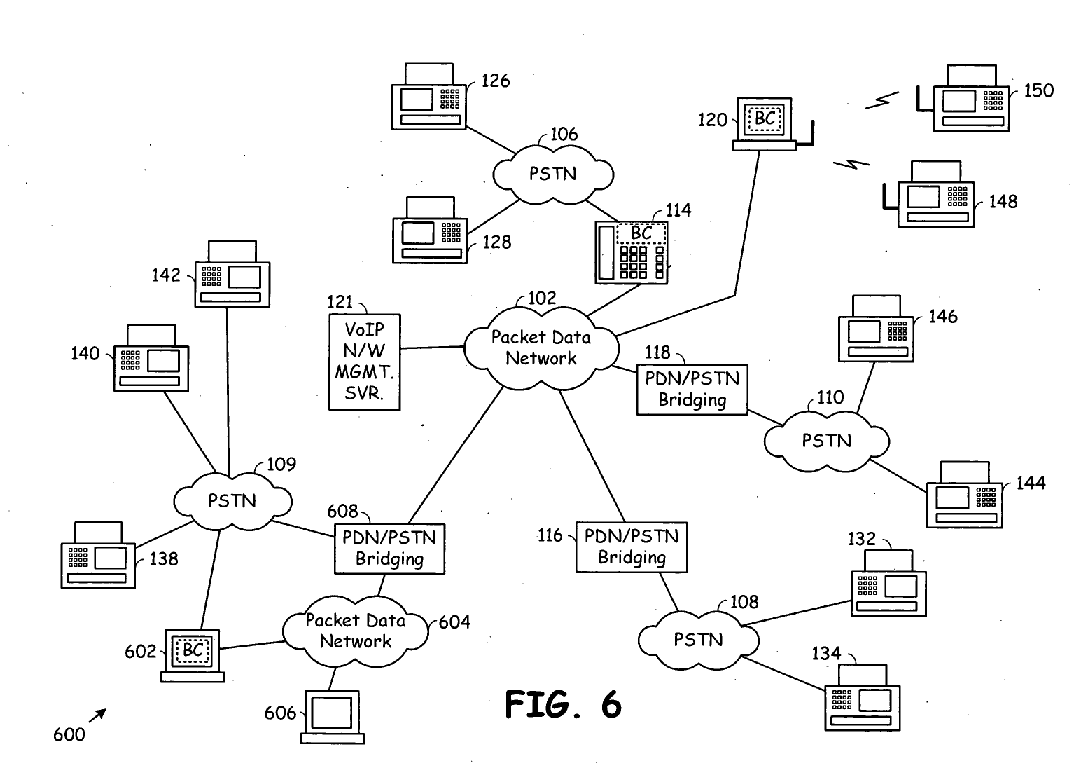

FIG. 6 is a system diagram illustrating an alternate embodiment of the system of FIG. 1 used to service the broadcast FAX transmissions according to at least one embodiment of the present invention. The system 600 of FIG. 6 includes components similar and/or same as those illustrated in FIG. 1. Such similar/same components retain common numbering to those illustrated in FIG. 1. Additional components illustrated in FIG. 6 include telephony bridging device 602, telephony bridging device 608, packet data network 604, and computer 606. As is shown, telephony bridging device 608 has connection to PSTN segment 104, packet data network 102, and packet data network 604.

According to one aspect of the present invention, telephony bridging device 602 broadcasts a FAX communication to a plurality of destination FAX machines having corresponding FAX numbers. For example, the telephony bridging device 602 desires to send a FAX communication to each of FAX machines 138, 140, 142, 126, 128, 148, 150, 134, 132, 144, and 146. Further, the telephony bridging device 602 desires to send the FAX communication to computer 606. Thus, each of the FAX machines to which the FAX communication is intended will have a corresponding FAX number.

In a first operation to accomplish this result, the telephony bridging device 602 determines a direct delivery subset of the plurality of destination FAX numbers and a bridged delivery subset of the plurality of destination FAX numbers. The direct delivery subset of the plurality of destination FAX numbers are accessible via a local PSTN segment 109. Thus, in this example, FAX machines 138, 140, and 142 would be within the direct delivery subset of the plurality of destination FAX numbers. Thus, the telephony bridging device 602 would transmit the FAX communication via a direct delivery PSTN connection to each of FAX machines 138, 140, and 142 using corresponding destination FAX numbers.

Then, for each destination FAX number of the bridged delivery subset of the plurality of FAX numbers, the telephony bridging device 602 performs another set of operations. As a first operation, the bridging circuitry of the telephony bridging device 602 will identify a destination telephony bridging device based upon the corresponding FAX number. For example, for FAX machines 132 and 134, the telephony bridging device 602 will identify the telephony bridging device 116 as the destination telephony bridging device. The telephony bridging device 602 will then transmit the FAX communications to the destination telephony bridging device 116 via packet data networks 602 and 102. The destination telephony bridging device 116 will then transmit the FAX communication to the corresponding FAX numbers of FAX machines 132 and 134 via PSTN segment 108.

For FAX machines 144 and 146, destination telephony bridging device 118 will receive the FAX communication from device 602 and deliver the FAX communication via PSTN segment 110. Likewise, destination telephony bridging device 114 services FAX communications to FAX machines 126 and 128. Further, telephony bridging device 120 services FAX communications for FAX machines 148 and 150.

Finally, FAX communication intended for computer 606 is delivered directly via packet data network 604 without usage of the PSTN at all. In such case, the file format delivered to computer 606 may simply be an image data format instead of a format that can be transmitted via the PSTN segment 104, 106, or 108. As was the case with delivery of FAX communications previously described with reference to FIGS. 1-4, the FAX communications that are broadcast by device 602 may be converted to an audio image data format, or a packetized audio format for transmission in various operations.

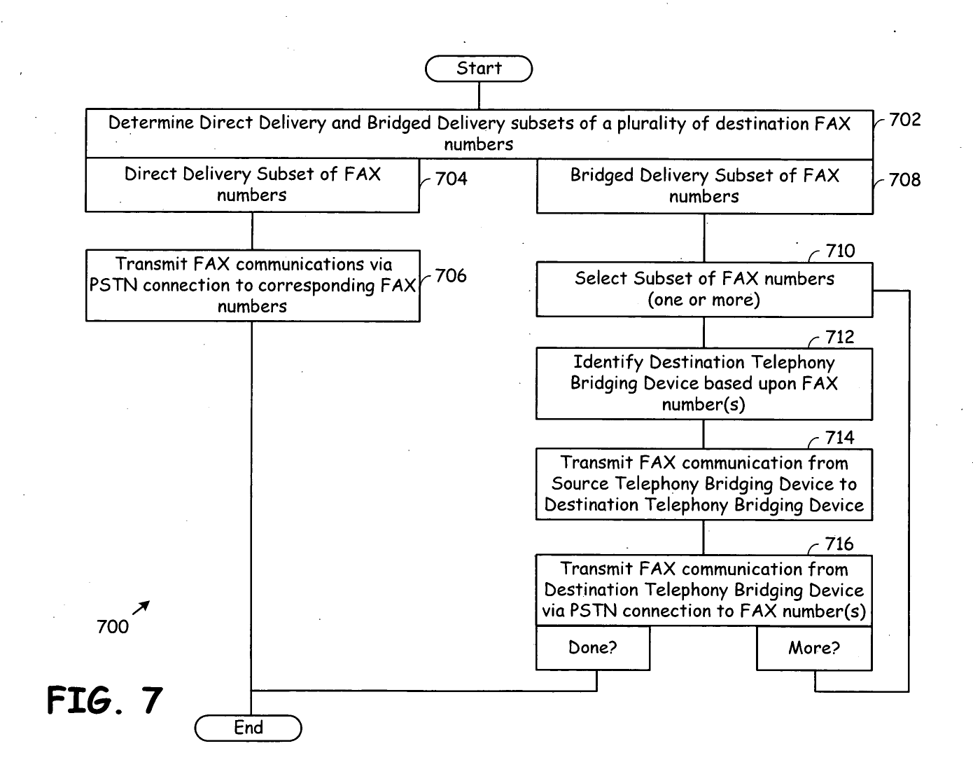

FIG. 7 is a flow chart illustrating a method for servicing broadcast FAX communications according to one or more embodiments of the present invention. Referring now to FIG. 7, operation 700 commences with determining the direct delivery and bridged delivery subsets of the plurality of destination FAX numbers (Step 702). For the direct delivery subset of FAX numbers (Step 704), the FAX communications are transmitted via a PSTN connection to corresponding FAX numbers (Step 706). Thus, at Step 706, no bridging between a PSTN format and a packet data format is required since the FAX communication is transmitted directly via PSTN.

For the plurality of bridged delivery subset of FAX numbers (Step 708) operation includes Steps 710-716. In a first operation, the plurality of destination FAX numbers are grouped into subsets of FAX numbers (Step 710). Each subset of FAX numbers includes one or more FAX numbers and may be serviced by a common PSTN connection. For example, one destination FAX number may correspond to one destination telephony bridging device while another plurality of FAX numbers may correspond to a differing destination telephony bridging device. Thus, for each subset of FAX numbers operation includes identifying a destination telephony bridging device based upon the FAX numbers (Step 712). Then, the FAX communication is transmitted from the source telephony bridging device to the destination telephony bridging device (Step 714). The FAX communication may be transmitted in the packetized audio format, an image format, or another format. Then, the destination telephony bridging device transmits the FAX communications via a PSTN connection to each of the FAX numbers in the subset of FAX numbers of a plurality of bridged delivery subset of FAX numbers. If all of the bridged delivery subset of FAX numbers has been transmitted operation ends. However, if more of the bridged delivery subset of FAX communications require servicing, operation returns to Step 710.

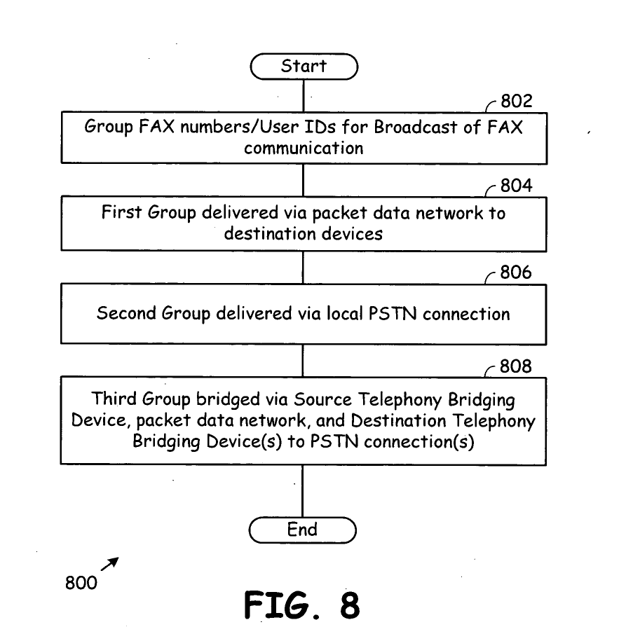

FIG. 8 is a flow chart illustrating another embodiment for the broadcast of FAX communications according to embodiments of the present invention. FIG. 8 illustrates in general, how differing delivery methodologies are employed for FAX communications. Operation 800 commences at Step 802 where a plurality of FAX numbers are grouped for broadcast. In alternate operation, the FAX communication may be simply intended for one or more users (corresponding user IDs) within a peer-to-peer VoIP network. In such case, a communication that is generally referred to as a FAX communication may be serviced apart from using a FAX format. Then, a first group of FAX communications is delivered via packet data network to a corresponding plurality of destination devices (Step 804). These FAX communications are delivered to the destination devices without requiring transmission across a PSTN. For example, as was described with reference to FIG. 6, the FAX communication may be delivered directly from device 602 to computer 606 without intervention with PSTN. Then, operation includes delivering FAX communications in a second group via local PSTN connection to a corresponding plurality of FAX machines (Step 806). With the operation of Step 806, only the PSTN is employed to delivery FAX communications to a plurality destination FAX machines. Then, operation includes delivering a third group of FAX communications via bridging operations that were previously described (Step 808). Generally, third group of FAX communications is bridged via source telephony bridging device, packet data network, and one or more destination telephony bridging devices to corresponding PSTN connections. The corresponding PSTN connections carry the FAX communications to their alternate destinations of the destination FAX machines.

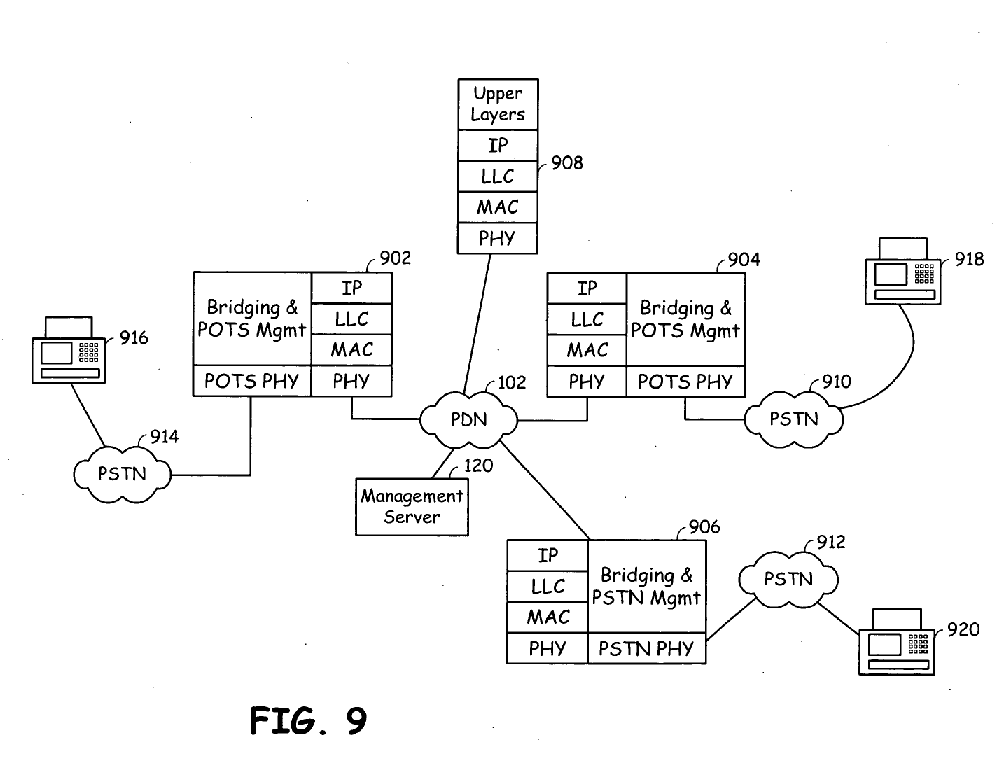

FIG. 9 is a system diagram illustrating the construction and operation of a plurality of telephony bridging devices according to embodiments of the present invention. Various protocol operations and protocol stacks used according to the present invention are described with reference to FIG. 9. Telephony bridging devices 902, 904, and 906 serve to bridge FAX communications between packet data networks and corresponding PSTN segments. For example, telephony bridging device 902 bridges FAX communications between packet data network 102 and PSTN segment 914. In performing such telephony bridging operations, the telephony bridging device 902 includes an IP protocol stack including IP layer, LLC layer, MAC layer, and PHY layer, which provide an interface to packet data network 102. Further, telephony bridging device 902 services PSTN layers that include at least a bridging and POTS management and a POTS PHY layer that are used to interface to PSTN segment 914. Telephony bridging device 904 includes similar/same protocol stacks and their corresponding operations for bridging between packet data network 102 and PSTN segment 910. Bridging device 906 includes similar protocol stacks used to interface with the packet data network 102 but connects to a differing type of PSTN segment 912. Such differing type could include a DSL connection, an ISDN connection, or another type of PSTN interface differing from the POTS format. Resultantly, the bridging device may support differing PSTN protocol layers. FAX machine 916 couples to PSTN segment 914, FAX machine 918 couples to PSTN segment 910, and FAX machine 920 couples to PSTN segment 912.

As was previously described in some operations, a telephony bridging device may deliver a FAX directly to a computer 908 via the packet data network 102. This computer 908 is shown to include protocol layers sufficient to service interface to packet data network 102. In such case, the computer 908 includes an Internet protocol stack and upper layer protocols that enable the transfer of the FAX communication in an image data format from the packet data network 102. Various file formats and transports may be employed to transfer the image file from one or more of the telephony bridging devices 902, 904, or 906 to the computer 908.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Likewise, a first circuit and a second circuit may be combined in one embodiment into a single circuit or, in another embodiment, operate independently perhaps in separate chips. The term “chip”, as used herein, refers to an integrated circuit. Circuits and circuitry may comprise general or specific purpose hardware, or may comprise such hardware and associated software such as firmware or object code.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A method for servicing an incoming Facsimile (FAX) communication comprising:
receiving the incoming FAX communication by a source telephony bridging device via a source PSTN connection, the incoming FAX communication having an incoming FAX number associated therewith;
based upon the incoming FAX number, determining a user ID in a peer-to-peer Voice over Internet Protocol (VoIP) network;
determining an Internet Protocol (IP) address of a destination telephony bridging device based upon the user ID in the peer-to-peer VoIP network;
determining an outgoing FAX number based upon the user ID in the peer-to-peer VoIP network; and
the source telephony bridging device, an intermediate packet data network, and the destination telephony bridging device bridging the FAX communication from the source PSTN connection to a destination PSTN connection, the FAX communication directed to the outgoing FAX number.

2. The method of claim 1, wherein the source PSTN connection is geographically remote from the PSTN connection.

3. The method of claim 1, further comprising:
the source telephony bridging device converting the FAX communication from a PSTN format to a packetized audio format; and
the destination telephony bridging device converting the FAX communication from the packetized audio format to the PSTN format.

4. The method of claim 1, further comprising:
the source telephony bridging device converting the FAX communication from a PSTN format to an image data format; and
the destination telephony bridging device converting the FAX communication from the image data format to the PSTN format.

5. The method of claim 1, further comprising:
the source telephony bridging device converting the FAX communication from a PSTN format to an image data format; and
delivering the FAX communication in the image data format to a destination device.

6. The method of claim 1, wherein the source telephony bridging device comprises one of personal computer, a bridging telephone, and a set top box.

7. A method for servicing a plurality of incoming Facsimile (FAX) communications, the method comprising:
by each of a plurality of source telephony bridging devices:
receiving an incoming FAX communication having an incoming FAX number associated therewith at a source PSTN connection;
based upon the incoming FAX number, determining a user ID in a peer-to-peer Voice over Internet Protocol (VOIP) network and an outgoing FAX number of the single destination FAX machine;
determining an Internet Protocol (IP) address of a destination telephony bridging device based upon the user ID of the peer-to-peer VoIP network; and
transmitting the incoming FAX communication to the destination telephony bridging device; and
by the destination telephony bridging device:
receiving the incoming FAX communications from the plurality of source telephony bridging devices, each incoming FAX communication identifying the user ID of the peer-to-peer VoIP network;
identifying a destination FAX number based upon the user ID of the peer-to-peer VoIP network;
receiving the incoming FAX communications from the source telephony bridging device via the at least one servicing packet data network; and
transmitting the FAX communications via a destination PSTN connection to the outgoing FAX number.

8. The method of claim 7, wherein each source PSTN connection is geographically remote from the destination PSTN connection.

9. The method of claim 7, further comprising:
at least one source telephony bridging device converting the FAX communication from a PSTN format to a packetized audio format; and
the destination telephony bridging device converting the FAX communication from the packetized audio format to the PSTN format.

10. The method of claim 7, further comprising:
at least one source telephony bridging device converting the FAX communication from a PSTN format to an image data format; and
the destination telephony bridging device converting the FAX communication from the image data format to the PSTN format.

11. The method of claim 1, further comprising:
at least one source telephony bridging device converting the FAX communication from a PSTN format to an image data format; and
delivering at least one FAX communication in the image data format to a destination device.

12. The method of claim 7, wherein each of the plurality of source telephony bridging devices comprises one of personal computer, a bridging telephone, and a set top box.

13. A method for servicing a broadcast Facsimile (FAX) communication to a plurality of destination FAX machines having corresponding FAX numbers, the method comprising:
determining a direct delivery subset of the plurality of destination FAX numbers and a bridged delivery subset of the plurality of destination FAX numbers;
for each corresponding FAX number of the direct delivery subset of the plurality of FAX numbers, transmitting the FAX communication via a direct delivery PSTN connection directed to the corresponding FAX number;
for each destination FAX number of the bridged delivery subset of the plurality of FAX numbers:
identifying a destination telephony bridging device based upon the corresponding destination FAX number;
transmitting the FAX communication from the source telephony bridging device to the destination telephony bridging device via a packet data network; and
transmitting the FAX communications from the destination telephony bridging device to the corresponding FAX number via a destination PSTN connection.

14. The method of claim 13, wherein identifying the destination telephony bridging device based upon the corresponding destination FAX number comprises:
determining a user ID in a peer-to-peer Voice over Internet Protocol (VoIP) network based upon the incoming FAX number; and
determining the destination telephony bridging device based upon the user ID in the peer-to-peer VoIP network.

15. The method of claim 13, further comprising, for at least one destination FAX number of the bridged delivery subset the plurality of FAX numbers:
the source telephony bridging device converting the FAX communication from a PSTN format to a packetized audio format; and
the destination telephony bridging device converting the FAX communication from the packetized audio format to the PSTN format.

16. The method of claim 13, further comprising:
converting the broadcast FAX communication from a PSTN format to an image data format; and
a destination telephony bridging device converting the FAX communication from the image data format to the PSTN format.

17. The method of claim 13, further comprising:
converting the broadcast FAX communication from a PSTN format to an image data format; and
delivering the FAX communication in the image data format to a destination device.

18. The method of claim 14, wherein at least one destination telephony bridging device comprises one of personal computer, a bridging telephone, and a set top box.

19. A telephony bridging device used in a telephony infrastructure including a circuit switched network and the PSTN, the telephony bridging device comprising:
packet switched interface circuitry that supports a call pathway to the packet switched network;
PSTN interface circuitry that supports a call pathway to the PSTN;
processing circuitry coupled to the circuit switched interface circuitry and the PSTN circuitry; and
the processing circuitry operable to:
receive an incoming FAX communication via the circuit switched interface, the incoming FAX communication having an incoming FAX number associated therewith;
based upon the incoming FAX number, determine a user ID in a peer-to-peer Voice over Internet Protocol (VOIP) network;
determine an Internet Protocol (IP) address of a destination telephony bridging device based upon the user ID in the peer-to-peer VoIP network;
determine an outgoing FAX number based upon the user ID in the peer-to-peer VoIP network; and
transmit the FAX communication to the destination telephony bridging device via the packet switched interface, the FAX communication directed to the outgoing FAX number via the destination telephony bridging device.

20. The telephony bridging device of claim 19, wherein the telephony bridging device and the destination telephony bridging device are geographically remote from one another.

21. The telephony bridging device of claim 19, the processing circuitry further operable to:
convert the FAX communication from a PSTN format to a packetized audio format; and
transmit the FAX communication in the image data format to the destination telephony bridging device via the packet data interface in the packetized audio format.

22. The telephony bridging device of claim 19, the processing circuitry further operable to:
convert the FAX communication from a PSTN format to an image data format; and
transmit the FAX communication via the packet data interface in the image data format to the destination telephony bridging device.

23. The telephony bridging device of claim 19, wherein the source telephony bridging device comprises one of personal computer, a bridging telephone, and a set top box.

24. A telephony bridging device used in a telephony infrastructure including a circuit switched network and the PSTN, the telephony bridging device comprising:
packet switched interface circuitry that supports a call pathway to the packet switched network;
PSTN interface circuitry that supports a call pathway to the PSTN;
processing circuitry coupled to the circuit switched interface circuitry and the PSTN circuitry; and
the processing circuitry operable to:
receive a broadcast Facsimile (FAX) communication intended for a plurality of destination FAX machines having corresponding FAX numbers;
determine a direct delivery subset of the plurality of destination FAX numbers and a bridged delivery subset of the plurality of destination FAX numbers;
for each corresponding FAX number of the direct delivery subset of the plurality of FAX numbers, transmit the FAX communication via the PSTN interface circuitry directed to the corresponding FAX number;
for each destination FAX number of the bridged delivery subset the plurality of FAX numbers:
identify a destination telephony bridging device based upon the corresponding destination FAX number;
transmit the FAX communication to the destination telephony bridging device via the packet switched interface circuitry along with the corresponding FAX number.

25. The telephony bridging device of claim 24, wherein in identifying the destination telephony bridging device based upon the corresponding destination FAX, the processing circuitry is operable to:
determine a user ID in a peer-to-peer Voice over Internet Protocol (VOIP) network based upon the incoming FAX number; and
determine the destination telephony bridging device based upon the user ID in the peer-to-peer VoIP network.

26. The telephony bridging device of claim 24, the processing circuitry further operable to:
convert the FAX communication from a PSTN format to a packetized audio format; and
transmit the FAX communication in the image data format to the destination telephony bridging device via the packet data interface in the packetized audio format.

27. The telephony bridging device of claim 24, the processing circuitry further operable to:
convert the FAX communication from a PSTN format to an image data format; and
transmit the FAX communication via the packet data interface in the image data format to the destination telephony bridging device.

28. The telephony bridging device of claim 24, wherein the source telephony bridging device comprises one of personal computer, a bridging telephone, and a set top box.
